(19) United States
(12) Patent Application Publication
(10) Pub. No.: US 2026/0073357 A1
(43) Pub. Date: Mar. 12, 2026

(54) CANDIDATE ANALYSIS TECHNIQUES FOR RECRUITING SYSTEMS

(71) Applicant: Scout Exchange LLC, Boston, MA (US)

(72) Inventors: John H. Chuang, Brookline, MA (US); Aarthi Narayan, Overland Park, KS (US); Paul Miller, Apex, NC (US); Robert Green, Wenham, MA (US)

(73) Assignee: Scout Exchange LLC, Boston, MA (US)

(21) Appl. No.: 19/324,017

(22) Filed: Sep. 9, 2025

Related U.S. Application Data
(60) Provisional application No. 63/693,595, filed on Sep. 11, 2024.

(51) Int. Cl. G06Q 10/1053; G06N 20/00

(52) U.S. Cl. CPC G06Q 10/1053; G06N 20/00

(57) ABSTRACT

According to various aspects, systems and methods are provided for automatically matching candidates to job openings. The system may obtain a job request and determine recommended candidates. The recommended candidates may be determined by identifying candidate profiles based on the job request; providing, as inputs to a trained machine learning model, the job request and a first set of questions related to the job request; generating, using the trained machine learning model, a first set of answers based on the job request and the first set of questions; providing, as inputs to the trained machine learning model, the candidate profiles and a second set of questions related to the candidate profiles; generating, using the trained machine learning model, second sets of answers based on the candidate profiles and the second set of questions; and determining the recommended candidates based on the first and second sets of answers.

### FIELD OF THE DISCLOSURE

The present disclosure relates to systems for recruiting and placing workers.

### BACKGROUND

Hiring companies and search firm and/or staffing companies may utilize computer systems to manage candidates and applicants for open jobs. For example, a recruiting platform may be used to manage the recruiting processes for one or more open job positions. Data may be submitted to recruiting platforms by hiring parties, recruiter users and candidates for analysis, as part of a recruiting process. Recruiting platforms may perform analyses on submitted data and provide results related to the candidates within the recruiting process.

### SUMMARY OF THE DISCLOSURE

According to one aspect a method for matching of job candidates to job openings is provided. The method comprises obtaining a job request, the job request including data related to an open job position determining one or more recommended candidates for the job request, at least in part by: identifying a first plurality of candidate profiles from a database based on the job request, each candidate profile being associated with a respective candidate, providing, as inputs to a first trained machine learning model, the job request and a first set of questions related to the job request, generating, using the first trained machine learning model, a first set of answers based on the job request and the first set of questions, providing, as inputs to the first trained machine learning model, the first plurality of candidate profiles and a second set of questions related to the candidate profiles, generating, using the first trained machine learning model, a plurality of second sets of answers based on the plurality of candidate profiles and the second set of questions, and determining the one or more recommended candidates based on the first and second sets of answers, and displaying a representation of the one or more recommended candidates on a user interface.

According to one embodiment, determining the one or more recommended candidates based on the first and second sets of answers comprises: generating, using a second trained machine learning model, a first data embedding based on the first set of answers and a plurality of second data embeddings based on the plurality of second sets of answers, and determining, using a third trained machine learning model, a plurality of candidate prediction scores, each one of the plurality of candidate prediction scores being determined for each of plurality of second data embeddings, based on comparisons of the first data embedding and each of the plurality of second data embeddings, and wherein the act of determining the one or more recommended candidates is performed responsive to the act of determining the candidate prediction scores.

According to one embodiment, the data of the job request includes one or more of: an education requirement for the open position, a location for the open position, a salary for the open position, skills for the open position, certifications for the open position, daily responsibilities for the open position, workplace preferences for the open position, and order intake summaries for the open position.

According to one embodiment, a first candidate profile of the plurality of candidate profiles comprises data including a resume for a first candidate associated with the first candidate profile and one or more of: demographic information associated with the first candidate, recruiter notes associated with the first candidate, and interview notes associate with the first candidate.

According to one embodiment, identifying the first plurality of candidate profiles comprises an act of comparing data of a second plurality of candidate profiles stored in the database to data of the job request and identifying the first plurality of candidate profiles from the second plurality of candidate profiles based on the act of comparing.

According to one embodiment, the comparing comprises determining a level of matching between the data of the second plurality of candidate profiles and the data of the job request, and wherein candidate profiles of the first plurality of candidate profiles are identified when the level of matching exceeds a threshold level.

According to one embodiment, the first set of questions include questions related to desired skills for the open position, required skills for the open position, workplace attributes for the open position, and responsibilities for the open position.

According to one embodiment, the first set of questions is structured as a list of questions and further includes instructions for the first trained machine learning model to use in generating the first set of answers.

According to one embodiment, the second set of questions include questions related to skills of a candidate, work history of the candidate, education of a candidate, past workplace attributes of the candidate, and past performance of the candidate.

According to one embodiment, the second set of questions is structured as a list of questions and further includes instructions for the first trained machine learning model to use in generating the plurality of second sets of answers.

According to one embodiment, the second set of questions further includes instructions for determining the plurality of second sets of answers based on content of the candidate profiles of the first plurality of candidate profiles.

According to one embodiment, the first set of answers is structured as a list of answers to each of the first set of questions and the second set of answers is structured as a list of answers to each of the second set of questions.

According to one embodiment, the first set of answers is structured as a paragraph summarizing answers to the first set of questions and the second set of answers are structured as a paragraph summarizing answers to the second set of questions.

According to one embodiment, the first trained machine learning model is a large language model with a decoder-only transformer architecture.

According to one embodiment, the first trained machine learning model is a large language model with a decoder-only transformer architecture.

According to one embodiment, the second trained machine learning model is a large language model with an encoder-only transformer architecture and is fine-tuned to analyze information related to job postings and candidate profiles.

According to one embodiment, the third trained machine learning model is an artificial neural network configured to determine the candidate prediction scores based on the first data embedding and the second data embeddings.

According to one embodiment, the recommended candidates have candidate prediction scores greater than a threshold candidate prediction score.

According to one embodiment, the third trained machine learning model is trained using simulated candidate profiles, the simulated candidate profiles being generated using historic candidate profiles associated with one or more historic job requests stored in the database.

According to one embodiment, the method further comprises: obtaining updated candidate profiles of one or more candidates of the recommended candidates, the updated candidate profiles comprising new data related to the associated candidates with respect to the open job position.

According to one embodiment, the new data comprises notes on the candidates provided by one or more recruiter users.

According to one embodiment, the new data comprises notes on one or more candidate interviews conducted in relation to the open position.

According to one embodiment, the new data comprises transcripts of one or more candidate interviews conducted in relation to the open job position.

According to one embodiment, the method further comprises providing, as inputs to the first trained machine learning model the updated candidate profiles and a third set of questions related to the new data, with respect to the open job position, generating, using the first trained machine learning model, a plurality of third sets of answers based on the updated candidate profiles and the third set of questions, and updating the recommended candidates based on the plurality of third sets of answers.

According to one embodiment, the method further comprises obtaining updated candidate profiles of one or more candidates of the recommended candidates, the updated candidate profiles comprising data related to the associated candidates with respect to the open job position, providing, as inputs to the first trained machine learning model the updated candidate profiles and a third set of questions related to the data related to the candidate profiles with respect to the open job position, generating, using the first trained machine learning model, a plurality of third sets of answers based on the updated candidate profiles and the third set of questions, generating, using the second trained machine learning model, a plurality of third data embeddings based on the plurality of third sets of answers, and determining, using the third trained machine learning model, updated candidate prediction scores for the candidates associated with each of plurality of third data embeddings.

According to one aspect a system for matching job candidates to job openings is provided. The system comprises a computer hardware processor, and a non-transitory computer readable storage medium, storing processor-executable instructions, that when executed by the computer hardware processor, cause the processor to perform a method for matching job candidates to a job opening, the method comprising: obtaining a job request, the job request including data related to an open job position, determining one or more recommended candidates for the job request, at least in part by: identifying a first plurality of candidate profiles from a database based on the job request, each candidate profile being associated with a respective candidate, providing, as inputs to a first trained machine learning model, the job request and a first set of questions related to the job request, generating, using the first trained machine learning model, a first set of answers based on the job request and the first set of questions, providing, as inputs to the first trained machine learning model, the first plurality of candidate profiles and a second set of questions related to the candidate profiles, generating, using the first trained machine learning model, a plurality of second sets of answers based on the plurality of candidate profiles and the second set of questions, and determining the one or more recommended candidates based on the first and second sets of answers, and displaying a representation of the one or more recommended candidates on a user interface.

According to one aspect at least one non-transitory computer readable storage medium, storing processor-executable instructions, that when executed by a computer hardware processor, cause the processor to perform a method for matching job candidates to a job opening is provided. The method comprises obtaining a job request, the job request including data related to an open job position, determining one or more recommended candidates for the job request, at least in part by: identifying a first plurality of candidate profiles from a database based on the job request, each candidate profile being associated with a respective candidate, providing, as inputs to a first trained machine learning model, the job request and a first set of questions related to the job request, generating, using the first trained machine learning model, a first set of answers based on the job request and the first set of questions, providing, as inputs to the first trained machine learning model, the first plurality of candidate profiles and a second set of questions related to the candidate profiles, generating, using the first trained machine learning model, a plurality of second sets of answers based on the plurality of candidate profiles and the second set of questions, and determining the one or more recommended candidates based on the first and second sets of answers; and displaying a representation of the one or more recommended candidates on a user interface.

According to one aspect a method for matching of job candidates to job openings is provided. The method comprises obtaining, from a database, historic job request, a plurality of historic candidate profiles associated with the historic job request and candidate performance information associated with historic candidate profiles of the plurality of historic candidate profiles, generating, using the plurality of historic candidate profiles and the candidate performance information, a plurality of simulated candidate profiles by: extracting data from plurality of historic candidate profiles to generate a plurality of candidate profile data segments, generating the plurality of simulated candidate profiles using the plurality of candidate profile data segments, wherein the simulated candidate profiles are generated by combining multiple candidate profile data segments of one or more historic candidate profiles, and determining a candidate quality score for each of the simulated candidate profiles, wherein the candidate quality scores are determined based on the candidate performance information associated with the candidate profile data segments used in generating the simulated candidate profiles, training a machine learning model using the plurality of simulated candidate profiles, the machine learning model configured to determine a candidate prediction score for one or more candidate profiles for a given job request, obtaining a new job request, the new job request including data related to an open position, obtaining a plurality of new candidate profiles, and using the trained machine learning model, determining a candidate prediction score for each of the plurality of new candidate profiles based on the new job request.

According to one embodiment, the historic job request comprises data related to a historic position, including one or more of: an education requirement for the historic position, a location for the historic position, a salary for the historic position, skills for the historic position, certifications for the historic position, daily responsibilities for the historic position, and workplace preferences for the historic position.

According to one embodiment, candidate profiles of the plurality of candidate profiles comprise a resume for an associated candidate and one or more of: demographic information for the associated candidate, prompt responses provided by the associated candidate, recruiter notes on the associated candidate, and interview information related to the associated candidate.

According to one embodiment, the candidate performance information associated with the historic candidate profiles of the plurality of historic candidate profiles comprises a rating for candidates associated with the historic candidate profiles with respect to the historic job request.

According to one embodiment, the candidate performance information associated with the historic candidate profiles of the plurality of historic candidate profiles comprises an indication of progress of candidates associated with the historic candidate profiles in a recruiting process for the historic job request.

According to one embodiment, the plurality of candidate profile data segments correspond to sections of a resume of a candidate associated with a historic candidate profile of the plurality of historic candidate profiles, including an education section, a work history section, and a skills section of the resume.

According to one embodiment, the candidate profile data segments further correspond to one or more of: demographic information of a candidate, prompt response provided by a candidate, recruiter notes on a candidate, and interview information for a candidate.

According to one embodiment, a first simulated candidate profile is generated using an education section of a resume associated with a first historic candidate profile, a work history section associated with a second historic candidate profile and a skills section associated with a third historic candidate profile.

According to one embodiment, generating the plurality of simulated candidate profiles comprises determining a candidate quality score for the plurality of simulated candidate profiles, wherein the candidate quality score for a first simulated candidate profile is determined based on the candidate performance information associated with the historic candidate profiles of the candidate profile data segments used to generate the first simulated candidate profile.

According to one embodiment, the plurality of simulated candidate profiles are generated according to a distribution of candidate quality scores.

According to one embodiment, the distribution of candidate quality scores is a normal distribution.

According to one embodiment, the distribution of candidate quality scores includes an equal number of strong, medium and weak simulated candidate profiles for the historic job request, wherein the strong simulated candidate profiles have a candidate quality score greater than a first threshold candidate quality score, the medium simulated candidate profiles have a candidate quality score less than the first threshold candidate quality score and greater than a second threshold candidate quality score, and the weak simulated candidate profiles have a candidate quality score less than the second threshold candidate quality score.

According to one embodiment, the simulated candidate profiles are generated using historic candidate profiles which are not associated with the historic job request.

According to one embodiment, wherein the simulated candidate profiles are generated at least in part by using a second machine learning model.

According to one embodiment, the training comprises; training the machine learning model using the candidate quality scores as ground truth measurements, determining, using the trained machine learning model, candidate prediction scores for the historic candidate profiles based on the historic job request, comparing the candidate prediction scores determined for the historic candidate profiles to the candidate performance information for the historic candidate profiles, updating the candidate quality scores based on results of the comparing, and training the machine learning model using the updated candidate quality scores as ground truth measurements.

According to one embodiment, the machine learning model is an artificial neural network.

According to one embodiment, the machine learning model comprises an input layer comprising 1750 dimensions, a hidden layer with 600 dimensions and an output layer.

According to one embodiment, the machine learning model is a first machine learning model, and training the first machine learning model comprises: providing as inputs to a second machine learning model, the historic job request and a first set of questions related to the job request, generating, using the second machine learning model, a first set of answers based on the historic job request and the first set of questions, providing as inputs to the second machine learning model, the plurality of simulated candidate profiles and a second set of questions related to the simulated candidate profiles, generating, using the second machine learning model, a plurality of second sets of answers based on the plurality of simulated candidate profiles and the second set of questions, generating, using a third machine learning model, a first data embedding based on the first set of answers and a plurality of second data embeddings based on the plurality of second sets of answers, and training the first machine learning model using the first data embedding, the plurality of second data embeddings, and the candidate quality scores associated with the plurality of simulated candidate profiles used to generate the plurality of second data embeddings.

According to one aspect a system for matching of job candidates to job openings is provided. The system comprises a computer hardware processor, and a non-transitory computer readable storage medium, storing processor-executable instructions, that when executed by the computer hardware processor, cause the processor to perform a method for matching job candidates to a job opening, the method comprising: obtaining, from a database, historic job request, a plurality of historic candidate profiles associated with the historic job request and candidate performance information associated with historic candidate profiles of the plurality of historic candidate profiles, generating, using the plurality of historic candidate profiles and the candidate performance information, a plurality of simulated candidate profiles by: extracting data from plurality of historic candidate profiles to generate a plurality of candidate profile data segments, generating the plurality of simulated candidate profiles using the plurality of candidate profile data segments, wherein the simulated candidate profiles are generated by combining multiple candidate profile data segments of one or more historic candidate profiles; and determining a candidate quality score for each of the simulated candidate profiles, wherein the candidate quality scores are determined based on the candidate performance information associated with the candidate profile data segments used in generating the simulated candidate profiles, training a machine learning model using the plurality of simulated candidate profiles, the machine learning model configured to determine a candidate prediction score for one or more candidate profiles for a given job request, obtaining a new job request, the new job request including data related to an open position, obtaining a plurality of new candidate profiles, and using the trained machine learning model, determining a candidate prediction score for each of the plurality of new candidate profiles based on the new job request.

According to one aspect at least one non-transitory computer readable storage medium, storing processor-executable instructions, that when executed by a computer hardware processor, cause the processor to perform a method for matching job candidates to a job opening is provided. The method comprises obtaining, from a database, historic job request, a plurality of historic candidate profiles associated with the historic job request and candidate performance information associated with historic candidate profiles of the plurality of historic candidate profiles, generating, using the plurality of historic candidate profiles and the candidate performance information, a plurality of simulated candidate profiles by: extracting data from plurality of historic candidate profiles to generate a plurality of candidate profile data segments, generating the plurality of simulated candidate profiles using the plurality of candidate profile data segments, wherein the simulated candidate profiles are generated by combining multiple candidate profile data segments of one or more historic candidate profiles, and determining a candidate quality score for each of the simulated candidate profiles, wherein the candidate quality scores are determined based on the candidate performance information associated with the candidate profile data segments used in generating the simulated candidate profiles, training a machine learning model using the plurality of simulated candidate profiles, the machine learning model configured to determine a candidate prediction score for one or more candidate profiles for a given job request, obtaining a new job request, the new job request including data related to an open position, obtaining a plurality of new candidate profiles, and using the trained machine learning model, determining a candidate prediction score for each of the plurality of new candidate profiles based on the new job request.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 shows an environment in which a recruiting platform is deployed, according to some embodiments.

FIG. 2 illustrates a process for analyzing candidates with respect to a job request, according to some embodiments.

FIG. 3 illustrates a process which may be performed by using machine learning models to determine candidate scores from candidate profiles, according to some embodiments.

FIG. 4A illustrates an example process for determining updated candidate scores based on additional candidate information, according to some embodiments.

FIG. 4B illustrates an example process for determining updated candidate scores based on additional candidate information using machine learning models, according to some embodiments.

FIG. 5 displays an example process flow for determining and displaying recommended candidates, according to some embodiments.

FIG. 6 illustrates an example process for training machine learning models on simulated candidate profiles, according to some embodiments.

FIG. 7 illustrates a process for validating the training of machine learning models trained using simulated candidate profiles, according to some embodiments.

FIG. 8 illustrates an example process for training a machine learning model using simulated candidate profiles, according to some embodiments.

FIG. 9 shows an example distributed computer system in which various aspects of the present application may be implemented.

FIG. 10A illustrates an example process for blind scoring a candidate which may be performed by machine learning models, according to some embodiments.

FIG. 10B illustrates an example process for generating a qualification report which may be performed by machine learning models using information used and generated by the process illustrated in FIG. 10A, according to some embodiments.

FIG. 10C illustrates an example process for generating an assessment of a potential candidate which may be performed by machine learning models using information used and generated by the processes illustrated in FIGS. 10A and 10B, according to some embodiments.

### DETAILED DESCRIPTION

The inventors have recognized that information obtained during recruiting processes for open job positions is not standardized and therefore is difficult to determine candidates that are best suited for open positions. For examples, different candidates may provide resumes which have different sections, styles of writing, formatting, and content within sections. This variance makes standardized analysis of information for recruiting processes difficult.

The inventors have appreciated that computerized models such as machine learning models may be useful in analyzing this varied data. Accordingly, according to some aspects, techniques are provided which leverage machine learning models to facilitate the analysis of information obtained during recruiting processes to determine the candidates which are best suited for an open job position. The techniques provided herein do not require standardized formatting of recruiting information and instead rely on processing of the language in the obtained recruiting information to identify the information necessary for determining the suitability of the candidates for an open position.

In some implementations, it is appreciated that an LLM-based system may be used where existing information (e.g., job descriptions, resumes), can be processed and compared without augmentation of the data. In some implementations, paired questions are asked of input documents such as job descriptions and resumes to produce an intermediate output which can be compared and/or graded. In this way, unstructured input data such as resume and job description data may be compared in a structured way, producing a more accurate output and therefore producing a more accurate and consistent output. Further, as these comparisons may be performed in real time, and the models can be retrained frequently, a more accurate matching system can be implemented. In accordance with some embodiments, it is appreciated that such a system provides more accurate comparisons in real time, allowing more accurate assessments of candidates.

The inventors have also recognized that historic data on job requests and associated candidate performance may be used in training machine learning models for predicting the suitability of candidates for a current open position. The inventors have further recognized that greater quantities of training data result in improved performance of machine learning models for predicting the suitability of candidates. Accordingly, the inventors have developed a technique of creating simulated candidate profiles, which incorporate data from historical candidates. This technique allows for larger training datasets to be generated from actual performance information of historical candidates. This provides larger quantities of data which may be used in training machine learning models, resulting in improved accuracy of the models. Further, such historical ground truth placement information can be used to train the models, and therefore more accurate predictions can be generated that predict, for example, probabilities that a candidate will progress through the interview process to certain levels. This prediction capability permits less user time in processing resume information and provides a more accurate recruiting system as a result.

In some embodiments, a recruiting talent platform is provided, that facilitates a recruiting process. The recruiting talent platform may be accessed, directly or indirectly via one or more interfaces, by hiring parties, recruiting parties, and candidates.

Hiring parties may include parties, such as an employer, employer representative, a hiring manager, or other entity, using the recruiting talent platform to manage hiring of one or more candidates for a job opening. The hiring parties may submit job requests related to open job positions via interfaces (e.g., graphical user interface(s)) to the recruiting talent software platform. A job request may specify a job opening at a respective employer. Job requests may be data structures storing information related to a job opening. A job request may specify information about the job such as: an education requirement for the open position, a location for the open position, a salary for the open position, desired or required skills for the open position, desired or required certifications for the open position, daily responsibilities for the open position, and workplace preferences for the open position. In some embodiments, the job request may include order intake summaries for the open position. The order intake summaries may be generated by recruiter users when a job request is received.

A recruiter user may include parties such as an individual recruiter, a staffing firm, staffing party, or other entity using the system to manage recruitment of candidates to one or more open positions. Candidates may include individuals currently seeking employment. Candidates may submit information to the recruiting talent platform. Candidates may submit information related to a specific job request or may submit information indicating they are seeking employment. Candidates may also be contacted by recruiter users who may provide information related to the candidates to the recruiting platform.

Candidate information submitted to the recruiting platform may be used to generate candidate profiles. Candidate profiles may be data structures storing information related to individual candidates. For example, candidate profiles may include a resume of a candidate, demographic information associated with a candidate, recruiter notes associated with a candidate, and interview notes associated with a candidate. A resume may include an education section, a work history section, and a skills section, which may be used in generating the candidate profile. In some embodiments, some or all of this information is used by one or more machine learning models to assess a particular candidate.

In some embodiments, candidate profiles and job requests may contain varying amounts of information depending on the source of the information. For example, a particular candidate or recruiter user may submit a resume which is short or incomplete, which results in a candidate profile with less information than one associated with a candidate who submitted a complete resume.

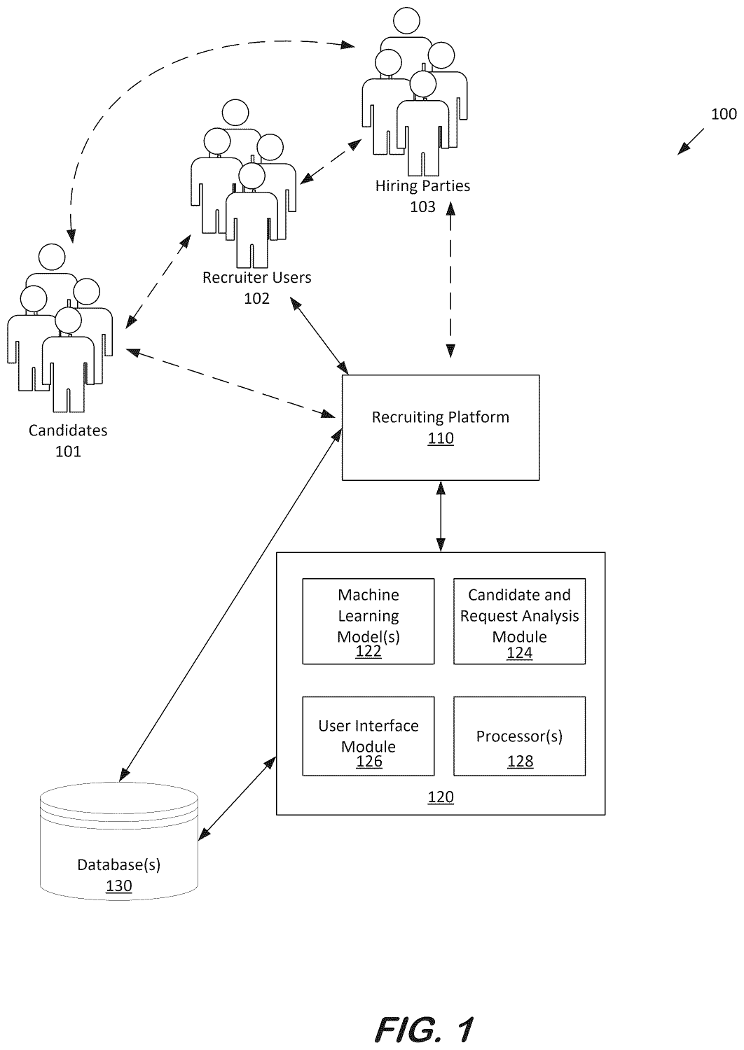

FIG. 1 shows an environment 100 in which a recruiting platform 110 is deployed. The environment includes candidates 101, recruiter users 102 and hiring parties 103, who may interact with each other and with the recruiting platform 110. The recruiting platform 110 is connected to a candidate analysis system 120, and the candidate analysis system is connected to one or more databases 130. The candidate analysis system 120 may be implemented as a part of the recruiting platform 110 or may be implemented separately. The databases 130 may be implemented as a part of the candidate analysis system 120 or may be implemented separately.

In some embodiments, candidates 101 may be individuals seeking employment via the recruiting platform. In some embodiments, the candidates may submit information to the recruiting platform, which may be used in generating candidate profiles. For example, the candidates may provide resumes, personal information, and demographic information to the recruiting platform which may be used to generate candidate profiles.

In some embodiments, hiring parties 103 may use the recruiting platform to submit and manage job requests for open positions. In some embodiments, the hiring parties 103 may submit information to the recruiting platform which may be used in generating a job request. In some embodiments, the hiring parties 103 may review candidate profiles of the candidates 101 or may conduct interviews with the candidates 101 as a part of the recruiting process. In some embodiments, the hiring parties 103 may provide information to the recruiting platform 110 related to the review of candidate profiles or to interviews, which may be used to update the candidate profiles within the recruiting platform 110.

In some embodiments, the recruiter users 102 may submit information to the recruiting platform 110. In some embodiments, the recruiting users may interact with the candidates 101, and may submit information to the recruiting platform 110 related to the candidates, for example resumes, demographic information, personal information, and notes on the candidates. This information may be used in generating candidate profiles within the recruiting platform 110. In some embodiments, the recruiter users 102 may interact with the hiring parties 103, and may submit information related to open positions to the recruiting platform 110, including an education requirement for the open position, a location for the open position, a salary for the open position, desired or required skills for the open position, desired or required certifications for the open position, daily responsibilities for the open position, and workplace preferences for the open position. This information may be used to generate a job request associated with the open position.

In some embodiments, the recruiting platform 110 may be implemented as a computer system for facilitating recruiting processes for one or more open positions. The recruiting platform may allow for the management of job requests and candidates during recruiting processes for open positions. In some embodiments, the recruiting platform 110 may generate candidate profiles and job requests based on information received from the candidates 101, recruiter users 102, and hiring parties 103. The recruiting platform may pass these candidate profiles and job requests to the databases 130 for storage or may pass them to the candidate analysis system 120 for analysis.

In some embodiments, the candidate analysis system 120 may facilitate a recruiting platform by performing one or more analyses on candidates with relation to an open job position. The candidate analysis system 120 includes machine learning models 122 and candidate and request analysis module, which may be used to facilitate the analysis of candidates. In some embodiments, the machine learning models may be used to generate scores associated with candidates with respect to a job request. In some embodiments, the candidate and request analysis module may perform filtering of candidates with respect to a job request. The candidate analysis system 120 additionally includes user interface module 126, which may be used to generate a user interface for displaying results of analyses and for one or more users, for example candidates 101, recruiter users 102 and hiring parties 103, to review or submit information related to a recruiting process. The candidate analysis system 120 may use processors 128 in performing the analysis of candidates.

Also shown in environment 100 are database(s) 130. The databases may store information which may be used in recruiting processes, for example candidate profiles, job requests, historic candidate profiles and associated performance information, and historic job requests.

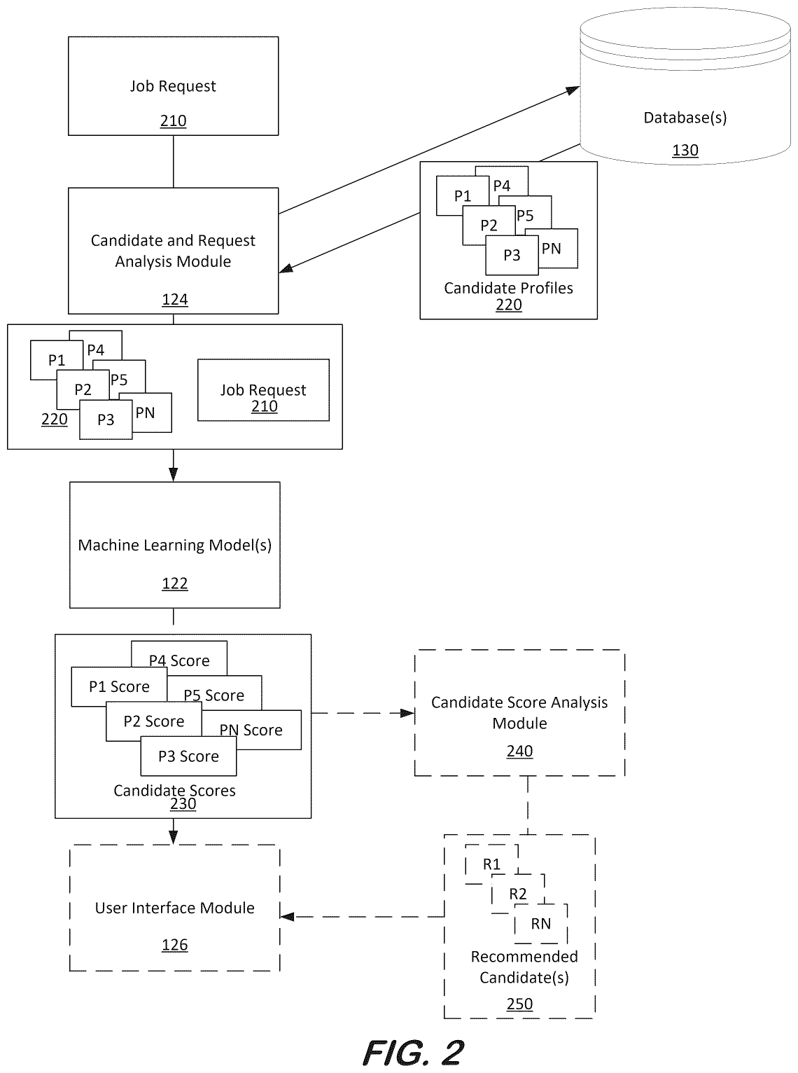

FIG. 2 illustrates a process for analyzing candidates with respect to a job request, according to some embodiments. The process for FIG. 2 may be performed by a candidate analysis platform such as 120 of FIG. 1.

Job request 210 is being analyzed in the process of FIG. 2, which includes information related to an open position. In some embodiments, the job request is received from a recruiting platform, such as 110 of FIG. 1. In some embodiments, the job request is received from databases 130.

The job request is passed to candidate and request analysis module, which may query the databases 130 to identify one or more candidate profiles which are suitable for the job request 210. In some embodiments, the candidate request and analysis module may identify candidate profiles based on one or more attributes of the candidate profiles, for example education, job history, skills, or certifications, among other attributes of the profiles. In some embodiments the candidate and request analysis module may identify candidate profiles when one or more attributes of the candidate profile match desired or required attributes of the job request. In some embodiments candidate profiles may be identified when they exceed a threshold level of matching. In some embodiments, the attributes used in matching may be selected by a user of the recruiting platform, for example a recruiter user or a hiring party. In some embodiments, the candidate profiles 220 are identified using keyword matching between the candidate profiles and the job request 210.

As shown, the candidate profiles 220 are obtained from the database 130. In FIG. 2, six candidate profiles are shown, however any suitable number of candidate profiles may be obtained from the database 130, for example less than six profiles, up to 10 profiles, up to 100 profiles, up to 1,000 profiles, up to 10,000 profiles or greater than 10,000 profiles.

The candidate profiles 220 and job request 210 may be passed to the machine learning models 122 for analysis. In some embodiments, additional data is passed to the machine learning models 122 for analysis, for example question sets associated with the candidate profiles or job request. The machine learning models may include one or more machine learning models which are configured to analyze the candidate profiles 220 with respect to the job request 210 to determine respective candidate scores 230 for the profiles 220. In some embodiments, the candidate scores represent the suitability of the candidate for the open position associated with the job request. The candidate scores may be any suitable scoring format. In some embodiments the candidate scores represent a prediction of how far a candidate will progress in the recruiting process for the open position. In some embodiments, the candidate scores are numeric scores representing the suitability of the candidates for the open position.

In some embodiments, the candidate scores 230 may be passed directly to the user interface module 126, which may generate a display relating to the candidate scores for the candidate profiles 220, for review by a user. In some embodiments, the candidate scores are passed to candidate score analysis module 240, which may determine one or more recommended candidates 250 based on the candidate scores 230. In some embodiments, the recommended candidates 250 have candidate scores 230 greater than a threshold score. In some embodiments, a top number of candidates are selected as recommended candidates, for example the top 5, 10, 15 or any other suitable number of candidates having the highest scores are selected as the recommended candidates. In some embodiments, the recommended candidates 250 are sent to the user interface module for displaying.

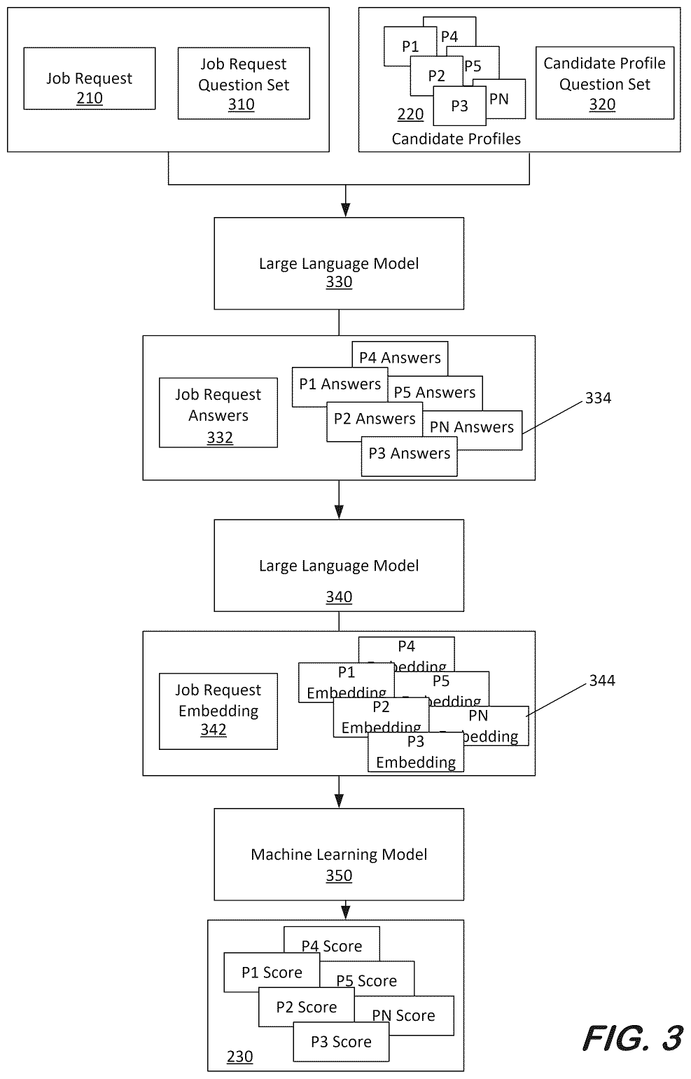

FIG. 3 illustrates a process which may be performed by using machine learning models to determine candidate scores from candidate profiles. As shown in FIG. 3, there are three machine learning models, Large Language Model (LLM) 330, LLM 340 and Machine Learning Model 350. The machine learning models may be structured as a single integrated model, separate models or a combination of integrated and separate models.

As shown in FIG. 3, the inputs to LLM 330 are job request 210, job request question set 310, candidate profiles 220, and candidate profile question set 320. The job request question set may include one or more questions related to the job request. In some embodiments the job request question set 310 is configured as a list of questions related to the job request. In some embodiments the job request question set 310 is configured as a data structure storing question related to the job request. In some embodiments the job request question set 310 is received from a database. In some embodiments, the job request question set 310 is configured by a user such as a recruiter user or hiring party and is received via a recruiting platform. In some embodiments, the questions of the job request question set 310 include one or more of: What skills are required for the position? What skills are preferred for the position? What skills and experience are needed for the job? What does a day in the life of a worker in this job look like? What does the day in the life of a candidate of a candidate for this job look like? What type of projects would this job require candidates to perform? What team at the company do they work for and what does that team focus on and who will they collaborate with? Also, what is unique about this role versus other similar roles at other companies?

In some embodiments, the questions of the job request question set 310 are not structured as questions, but are structured as requests, for example: Write a concise summary of the ideal candidate's skills and experience they need for the job. In some embodiments, the job request question set 310 may include instructions for the LLM 330 to use in generating answers to the questions, for example: describe it in one short paragraph, these skills are mandatory, and these skills are nice-to-have, among other instructions.

The candidate profile question set may include one or more questions related to candidate profiles 220. In some embodiments the candidate profile question set 320 is configured as a list of questions related to the candidate profiles 220. In some embodiments the candidate profile question set 320 is configured as a data structure storing question related to the candidate profile. In some embodiments the candidate profile question set 320 is received from a database. In some embodiments, the candidate profile question set 320 is configured by a user such as a recruiter user or hiring party and is received via a recruiting platform. In some embodiments, the questions of the candidate profile question set 320 include one or more of: What was their most recent job title? If they have taken a leave of absence for family or medical reasons, what was their most recent title in their profession? If they went to college, what did they major in? What are the candidate's skills and experience? What does a day in the life of this candidate in their current role look like? What is one specific project with the specific skills they use to succeed as at that project? What team at the company do they work for? What does that team focus on? Who do they collaborate with? What is unique about this role versus other similar roles at other companies? In some embodiments, the candidate profile question set 320 may include instructions for the LLM 330 to use in generating answers to the questions, for example: describe it in one short paragraph, write it as a first-person narrative, and make it brief, among other instructions.

In some embodiments the job request question sent 310 and the candidate profile question set 320 may include corresponding questions.

The job request question set 310 and candidate profile question set 320 may be sent to LLM 330 for analysis. The LLM 330 may generate answers to the questions within the question sets 310 and 320 based on the content of the job request 210 and the candidate profiles 220. In some embodiments the answers may be structured as English language text which answers each of the questions contained in the associated question set. In examples where the question sets include instructions for answering the questions or formatting of the answers, the LLM 330 is configured to follow the instructions in generating the answers to the questions.

In some embodiments, LLM 330 is configured with a decoder-only transformer architecture, however other architectures suitable for the analysis and generation of text may be used. In some embodiments, LLM 330 is fine tuned for the analysis of candidate profiles and job requests. In some embodiments, fine tuning the LLM 330 includes performing supervised fine-tuning by providing labeled candidate profiles and job requests, and example answers to the machine learning model. In some embodiments, fine-tuning the LLM 330 includes performing one or more of: hyperparameter tuning, transfer learning, multi-task learning, few-shot learning, or task-specific fine-tuning. In some embodiments, fine-tuning the LLM 330 includes performing reinforcement learning from human feedback, in which answers from the LLM may be reviewed and feedback may be provided to the LLM 330 to improve the quality of the responses. In some embodiments, fine-tuning of the LLM 330 may include performing unsupervised fine-tuning of the LLM.

The LLM 330 generates job request answers 332 and candidate profile answers 334 based on the inputs to the models. The answers include text representing the answers to the questions provided in the question sets 310 and 320. The answers 332 and 334 may be provided to a second LLM 340.

LLM 340 may be configured to generate data embeddings based on the answers received from LLM 330. The data embeddings may be numerical representation of the answers. In some embodiments, the data embeddings are vector representations of one or more features of the answers received from LLM 330. The LLM 340 may generate job request embedding 342 based on the job request answers 332. The LLM 340 may generate candidate profile data embeddings 344 based on the candidate profile answers 334.

In some embodiments, LLM 340 is configured with an encoder-only transformer architecture, however other architectures suitable for the analysis and generation of text may be used. In some embodiments, LLM 340 is fine tuned for generating the data embeddings based on the job request and candidate profile answers. In some embodiments, fine-tuning the LLM 340 includes performing one or more of: hyperparameter tuning, transfer learning, multi-task learning, few-shot learning, or task-specific fine-tuning, among other techniques for fine tuning.

The data embeddings 342 and 344 may be passed to machine learning model 350. Machine learning model 350 may be configured to generate the candidate scores 230 based in part on a comparison between the candidate profile data embeddings 344 and the job request data embedding 342.

In some embodiments, the machine learning model 350 may be structured as a regression model, including linear regression or logistic regression, as an example. In some embodiments, the machine learning model 350 may be structured as a random forest model. In some embodiments, the machine learning model 350 may be structured as a neural network. In some embodiments, the machine learning model 350 may be structured as a neural network with an input of around 1750 dimensions, one hidden layer with 600 dimensions, and an output layer.

In some embodiments, the embeddings may undergo processing before analysis by the machine learning model 350. In some embodiments, the cosine similarity between the job request embedding 342 and the candidate profile embeddings 344 is determined and provided as inputs to the machine learning model 350. In some embodiments, the element wise multiplication is taken between the job request embedding 342 and the candidate profile embeddings 344 and is provided as inputs to the machine learning model 350. In some embodiments, the cosine similarity and element wise multiplication is taken between the job request embedding 342 and the candidate profile embeddings 344 and provided as inputs to the machine learning model 350.

The machine learning model 350 may be trained using historic job requests, candidate profiles and performance information related the candidate profiles. The performance information related to the candidate profiles may indicate how far an associated candidate progressed in a recruiting process associated with the historic job request. In some embodiments, the performance information related to the candidate profiles may be used as ground truth data for training the machine learning model 350.

In some embodiments, additional analyses may be performed on the embeddings 342 and 344 in conjunction with that performed by machine learning model 350. In some embodiments, logistic regression may be performed to predict a score for the candidate profiles and their suitability for the open position associated with the job request, based on the data embeddings 342 and 344. In some embodiments, the candidate scores 230 may be determined based on the output of the machine learning model 350 and logistic regression.

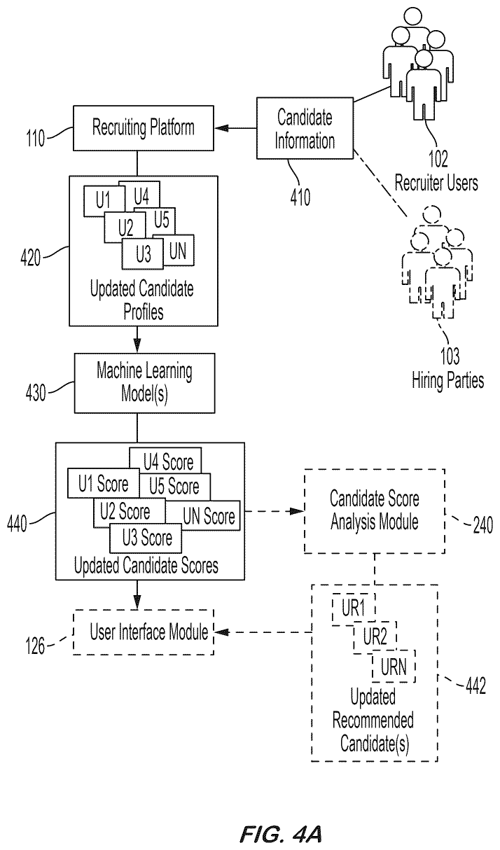

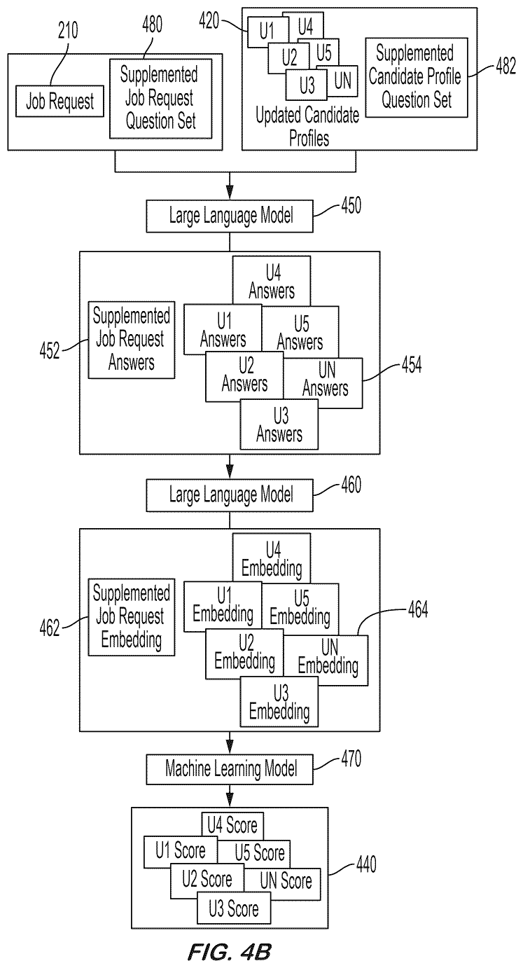

In some embodiments, additional information related to one or more candidates may be provided to a recruiting platform during a recruiting process. Examples of such information include notes on candidates, notes on candidate interview, and candidate interview transcripts, among other information. FIG. 4A illustrates an example process for determining updated candidate scores based on additional candidate information, according to some embodiments. In some embodiments this additional candidate information 410 is provided to recruiting platform 110 by recruiter users 102 and/or hiring parties 103.

Updated candidate profiles 420 may be generated using the candidate information 410. These updated candidate profiles may be provided to machine learning models 430. In some embodiments, additional data may be passed to the machine learning models 430, for example the job request, and question sets related to the updated candidate profiles and the job request.

In some embodiments, the machine learning models 430 may be configured as described with regard to FIGS. 1-3. In some embodiments, the machine learning models 430 may be trained and/or fine-tuned to analyze updated candidate profiles 420 including the candidate information 410. In some embodiments, the machine learning models 430 may analyze only the newly obtained candidate information 410 to determine the updated candidate scores 440. In some embodiments, the machine learning models 430 may analyze all information contained within the updated candidate profiles 420.

In some embodiments, the updated candidate scores 440 may be provided to the user interface module 126 for displaying. In some embodiments, the updated candidate scores 440 may be provided to candidate score analysis module 240, which may determine one or more updated recommended candidates 442. The updated recommended candidates may be provided to the user interface module 126 for displaying.

FIG. 4B illustrates an example process for determining updated candidate scores based on additional candidate information using machine learning models, according to some embodiments.

FIG. 4B includes three machine learning models LLM 450, LLM 460 and machine learning model 470. In some embodiments, the machine learning models 450, 460 and 470 may be configured the same as machine learning models 330, 340 and 350 as described with respect to FIG. 3, respectfully. In some embodiments, the machine learning models 450, 460 and 470 may be fine-tuned and/or trained for analyzing updated candidate profiles. The machine learning models 450, 460 and 470 may be fine-tuned and/or trained according to any suitable method as described herein.

Machine learning model 450 receives as inputs the job request 210, a supplemented job request question set 480, the updated candidate profiles 420 and a supplemented candidate profile question set 482.

In some embodiments, the supplemented job request question set 480 may include questions related to the job request, such as those described with reference to job request question set 310. In some embodiments, the supplemented job request question set 480 may include additional questions related to the updated candidate information, for example: how would the ideal candidate perform in an interview? or how would the ideal candidate answer the following interview question: Why would you be a good fit for this position?

In some embodiments, the supplemented candidate profile question set 482 may include questions related to the candidate profiles, such as those described with reference to candidate profile question set 320. In some embodiments, the supplemented candidate profile question set 482 may include additional questions related to the updated candidate information, for example: how did the candidate perform in the interview? or how did candidate answer the following interview question: Your resume highlights your expertise in creating over 200 documents for NOAA. Can you provide a specific example of a document you wrote that you were particularly proud of and why?”

In some embodiments, the LLM 450 generates supplemented job request answers 452 based on the job request and the supplemented job request question set 480. In some embodiments, the LLM 450 generates the updated candidate profile answers 454 based on the updated candidate profiles and the supplemented candidate profile question set 482.

The supplemented job request answers 452 and updated candidate profile answers 454 are passed to LLM 460. LLM 460 may generate data embeddings based on the supplemented job request answers 452 and updated candidate profile answers 454. In some embodiments, supplemented job request embedding 462 may be generated based on the supplemented job request answers 452. In some embodiments, the updated candidate profile embeddings 464 may be generated based on updated candidate profile answers 454.

The supplemented job request embedding 462 and updated candidate profile embeddings 464 are passed to machine learning model 470. In some embodiments, additional processing may be performed on the embeddings 462 and 464, for example, cosine similarities may be determined and cross wise multiplications may be taken, as described with reference to FIG. 3.

In some embodiments, the machine learning model 470 may determine the updated candidate profile scores 440 based on the supplemented job request embedding 462 and the updated candidate profile embeddings 464. In some embodiments, the machine learning model 470 may determine the updated candidate profile scores 440 based on a comparison of the updated candidate profile embeddings 464 to the supplemented job request embedding 462.

In some embodiments additional analyses may be performed when determining the updated candidate profile scores 440, for example linear regression may be performed as described with reference to FIG. 3.

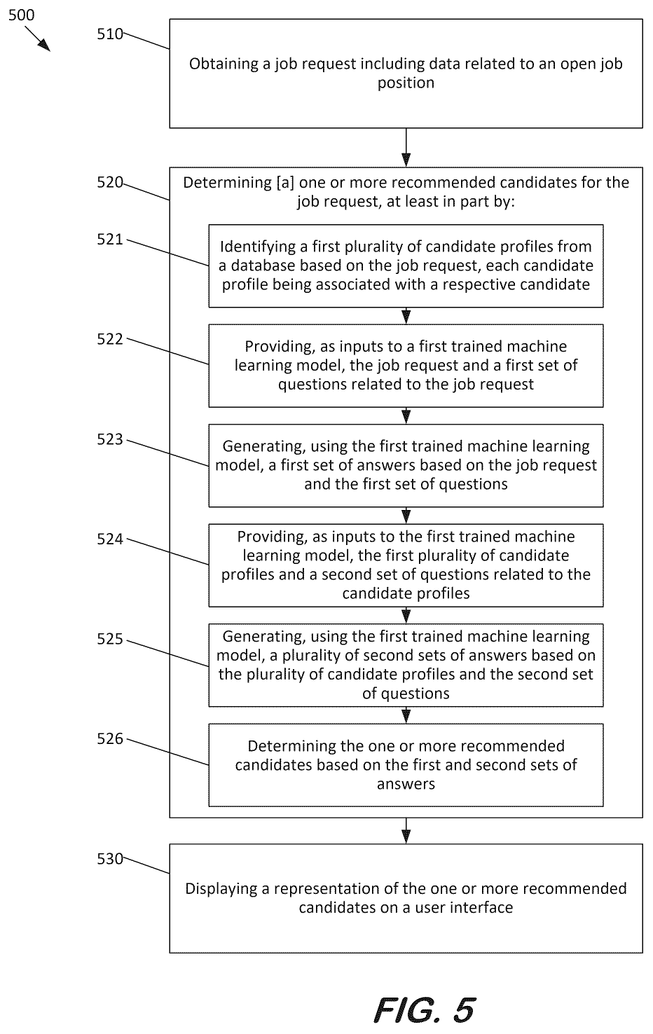

FIG. 5 displays an example process flow for determining and displaying recommended candidates, according to some embodiments. Process 500 may be performed by a recruiting platform and/or a candidate analysis platform, such as described with reference to FIG. 1.

Process 500 begins at step 510 in which a job request is obtained, the job request including data related to an open job position. In some embodiments, the job request may be obtained from a database or may be provided by a user, for example a recruiter user or a hiring party. The data related to the open job position may include data as described herein, for example an education requirement for the open position, a location for the open position, a salary for the open position, desired or required skills for the open position, desired or required certifications for the open position, daily responsibilities for the open position, and workplace preferences for the open position, among other data.

Process 500 then proceeds to step 520 in which one or more recommended candidates are determined for the job request. Step 520 includes sub steps 521-526. In some embodiments, step 520 may be performed by a candidate analysis platform such as 120 of FIG. 1. In some embodiments, step 520 may involve the processes described with respect to FIGS. 2-3.

Step 520 includes step 521, in which a first plurality of candidate profiles are identified from a database based on the job request, each candidate profile being associated with a respective candidate. In some embodiments, the candidate profiles are identified such as described with reference to candidate and request analysis module 124 in FIGS. 1-2. In some embodiments the candidate profiles are determined by performing a keyword matching based on the job request or by comparing one or more attributes of the candidate profiles to the job request.

Process 500 then proceeds to step 522, in which the job request and a first set of questions related to the job request are provided as inputs to a first trained machine learning model. In some embodiments, the first trained machine learning model is configured as an LLM, such as described with reference to FIG. 3. In some embodiments, the first set of questions include questions related to the job request, as described herein, for example as described with reference to FIG. 3. In some embodiments, the first set of questions includes instructions for generating answers, as described herein.

Process 500 then proceeds to step 523, in which a first set of answers are generated using the first machine learning model based on the job request and the first set of questions. In some embodiments, the first set of answers may be structured as English language text which answers each of the questions contained in the first question set. In examples where the first question set include instructions for answering the questions or formatting of the answers, the first machine learning model may be configured to follow the instructions in generating the answers to the questions.

Process 500 then proceeds to step 524, in which the first plurality of candidate profiles and a second set of questions related to the candidate profiles are provided as inputs to the first machine learning model. In some embodiments, the second set of questions include questions related to the candidate profiles, as described herein, for example as described with reference to FIG. 3. In some embodiments, the second set of questions includes instructions for generating answers, as described herein.

Process 500 then proceeds to step 525, in which a plurality of second sets of answers are generated using the first machine learning model based on the candidate profiles and the second set of questions. In some embodiments, the second set of answers may be structured as English language text which answers each of the questions contained in the second question set. In examples where the second question set include instructions for answering the questions or formatting of the answers, the first machine learning model may be configured to follow the instructions in generating the answers to the questions.

Process 500 then proceeds to step 526, in which the one or more recommended candidates are determined based on the first and second sets of answers. In some embodiments, step 526 involves performing a comparison of the first and second sets of answers and determining the recommended candidates based on the comparison.

Process 500 then proceeds to step 530, in which a representation of the one or more candidates is displayed on a user interface. In some embodiments, the user interface is an interface of a recruiting platform and may be viewed by a recruiter user or hiring party.

The techniques described herein for determining candidate scores improve the functioning of recruiting systems by providing more accurate indications of candidate suitability and reducing the processing required to determine candidate suitability. These benefits are realized because the candidate scores may be determined without requiring standardized formatting or content of data within candidate profiles and job requests. Varied content and formatting may be used with the techniques described herein because the language contained within the candidate profiles and job request is compared based on the question sets provided to the machine learning models. Therefore, the candidates are evaluated based on language, which provides more accurate analyses of the candidates and avoids issues which may be introduced through non-standardized formatting, non-standardized content, or poor data extraction. Accordingly, the techniques described herein provide improved analysis of candidates and more accurate indications of candidate suitability for open positions.

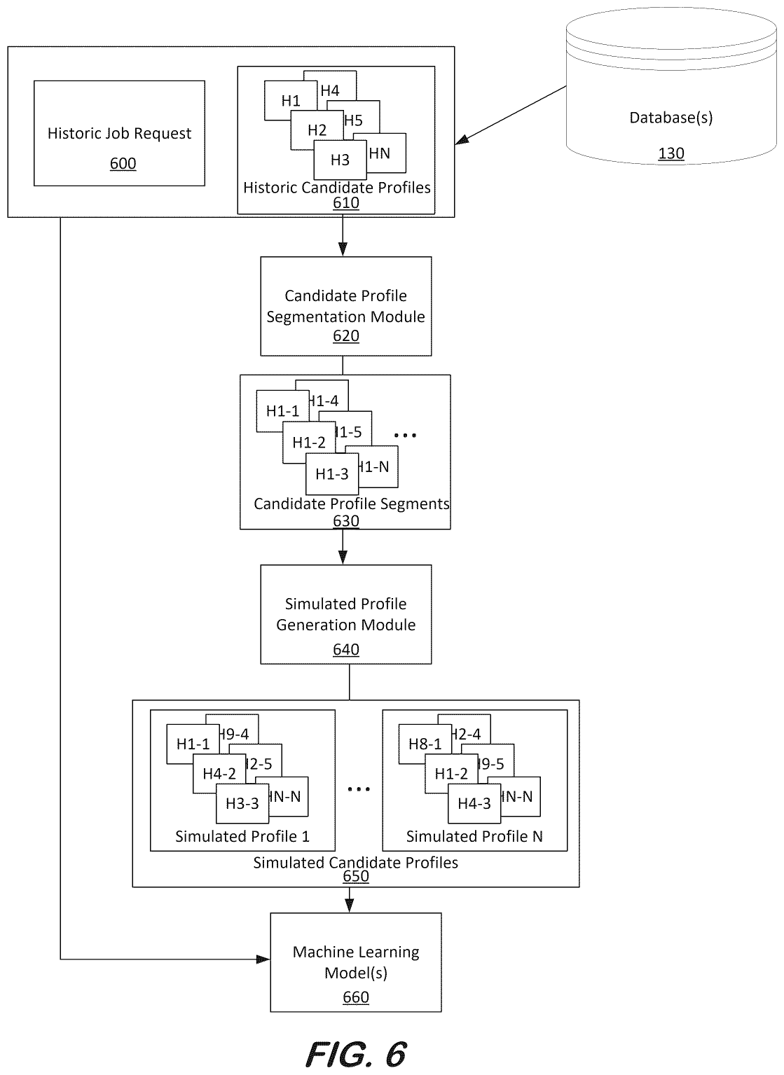

FIG. 6 illustrates an example process for training machine learning models on simulated candidate profiles, according to some embodiments. The process of FIG. 6 may be used to generate simulated candidate profiles which may be used in the training of machine learning models, such as those described herein with reference to FIGS. 1-4B.

A historic job request 600 and historic candidate profiles 610 are obtained from database(s) 130. In some embodiments, the historic job request 600 is associated with a previously open position, which has been filled. In some embodiments, the historic job request 600 includes data such as: an education requirement for the previously open position, a location for the previously open position, a salary for the previously open position, desired or required skills for the previously open position, desired or required certifications for the previously open position, daily responsibilities for the previously open position, workplace preferences for the previously open position and order intake summaries for the previously open position. In some embodiments, the historic candidate profiles include information related to candidate such as a resume of a candidate, demographic information associated with a candidate, recruiter notes associated with a candidate, and interview notes associated with a candidate. In some embodiments, the historic candidate profiles include information related to the performance of the associated candidate in the recruiting process for the previously open position. In some embodiments, the historic candidate profiles are associated with the historic job request. In some embodiments, the historic candidate profiles are not associated with the historic job request.

The historic candidate profiles 610 may be passed to candidate profile segmentation module 620, which generates candidate profile segments 630. In some embodiments, the candidate profile data segments may correspond to one or more portions of the candidate profile. In some embodiments, the candidate profile data segments 630 correspond to sections of a resume of the candidate profiles, for example, segments may correspond to an education section, a work history section, and a skills section of the resume. In some embodiments, the candidate profile data segments correspond to one or more of: a resume of a candidate, sections of the resume demographic information associated with a candidate, recruiter notes associated with a candidate, and interview notes associated with a candidate. In some embodiments, multiple candidate profile data segments are generated from each historic candidate profile 610. In some embodiments, the candidate profile data segments include information related to the performance of the associated candidate in the recruiting process for the previously open position.

The candidate profile data segments may be passed to the simulated candidate profile generation module 640. In some embodiments, the simulated candidate profile generation module may generate one or more simulated candidate profiles using the candidate profile segments 630. In some embodiments, the simulated candidate profile generation module generates a simulated candidate profile by combining candidate profile segments from one or more historic candidate profiles into a single simulated candidate profile. In some embodiments, a simulated candidate profile includes data segments from multiple historic candidate profiles.

In some embodiments, the simulated candidate profile generation module 640 determines a quality score associated with each simulated candidate profile. In some embodiments, the quality score is indicative of the suitability of the simulated candidate profile for the historic job request. In some embodiments, the quality scores are determined based on the performance information of the candidates associated with the historic candidate profiles used in generating the simulated candidate profiles. In some embodiments, the quality scores indicate if a simulated candidate profile is a strong, medium or weak profile. In some embodiments, strong profiles may include segments from candidates who made it far in the recruitment process such as to a final interview or who were hired for the previously open position. In some embodiments, medium profiles may include segments from candidates who made it far in the recruitment process or were hired, segments from candidates who progressed past initial rounds of the recruitment process, and segments from candidates who did not pass initial rounds of the recruitment process. In some embodiments, weak candidates may include segments from candidates who progressed past initial rounds of the recruitment process, and segments from candidates who did not pass initial rounds of the recruitment process.

In some embodiments the simulated profile generation module 640 is configured to generate simulated candidate profiles according to a distribution of quality scores. In some embodiments, the simulated profile generation module 640 is configured to generate simulated candidate profiles according to a normal distribution. In some embodiments, the simulated profile generation module 640 is configured to generate simulated candidate profiles according to a normal distribution skewed towards stronger candidates. In some embodiments, the simulated profile generation module 640 is configured to generate simulated candidate profiles according to a normal distribution skewed towards weaker candidates. In some embodiments the simulated profile generation module 640 is configured to generate equal numbers of strong and weak candidates based on the quality scores. In some embodiments the simulated profile generation module is configured to generate equal numbers of strong, medium and weak candidates. In some embodiments the candidate profile generation module is configured to generate a majority of strong, medium or weak candidates.

The simulated candidate profiles 650 may be provided along with the historic job request 600 and historic candidate profiles 610 for use in training machine learning models 660. The machine learning models 660 may include the models as described with respect to FIGS. 1-4B. In some embodiments, the simulated candidate profiles 650 are used in fine-tuning of machine learning models such as models 340, 350, 450 and 460. In some embodiments, the simulated candidate profiles 650 are used in training machine learning models, such as models 350 and 470. In some embodiments the quality scores are used as ground truth data for the machine learning models. In some embodiments, the simulated candidate profiles may undergo processing before use in training. For example, the simulated candidate profiles may be used to generate data embeddings of answers to questions associated with the profiles using machine learning models as described herein, in order to train a machine learning model configured to receive data embeddings as inputs, for example models 350 and 470.

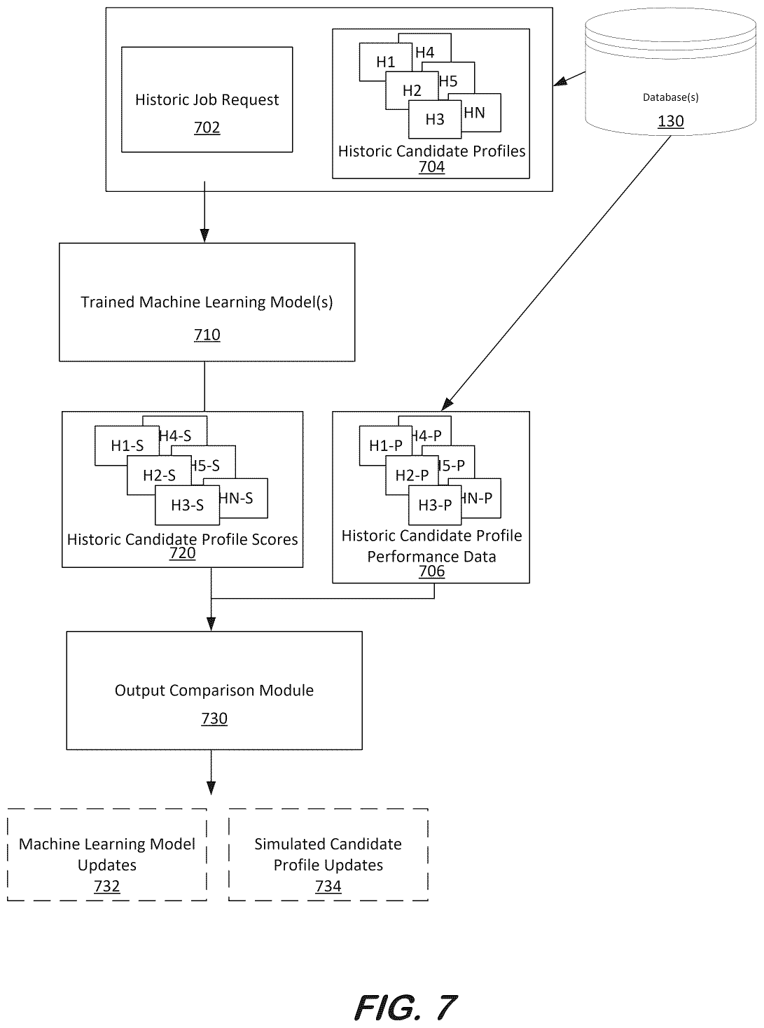

FIG. 7 illustrates a process for validating the training of machine learning models trained using simulated candidate profiles. The process of FIG. 7 may be performed to validate the training of machine learning models described herein, such as those described with reference to FIGS. 1-4B.

The trained machine learning model(s) 710 may be trained using simulated candidate profiles which may be generated using the process described with reference to FIG. 6.

The trained machine learning model 710 receives as inputs a historic job request 702 and historic candidate profiles 704, and outputs historic candidate profile scores 720. In some embodiments, the historic candidate profile scores 720 are indicative of the suitability of the candidates of the historic candidate profiles 704 for the previously open position associated with the historic job request 702.

The historic candidate profile scores 720 and historic candidate profile performance data 706 may be passed to output comparison module 730 for comparison. In some embodiments the historic candidate profile performance data includes indications of how far a candidate made it in a recruiting process for the previously open position associated with the historic job request. In some embodiments, the output comparison module 730 compares the historic candidate profile score for a particular profile to the performance data for the same profile to determine how accurately the trained machine learning models performed. In some embodiments, the scores may be compared to the performance data for all historic candidate profiles. In some embodiments, the results of the comparison are summarized to determine the performance of the machine learning model. in some embodiments, the output comparison model 730 generates machine learning model updates 732 based on the results of the comparison. In some embodiments, the output comparison model 730 generates simulated candidate profile updates 734 based on the results of the comparison. In some embodiments, the simulated candidate profile updates include changes to the quality scores of the simulated candidate profile, such as lowering the scores when the trained machine learning models 710 predict the candidates will perform better than they did.

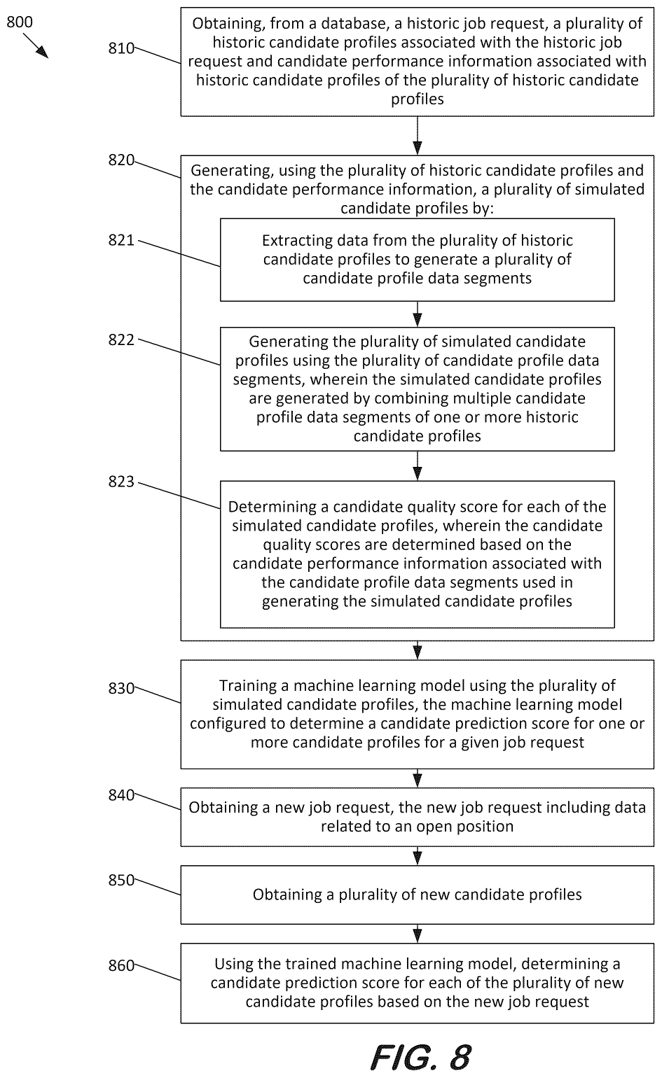

FIG. 8 illustrates an example process for training a machine learning model using simulated candidate profiles, according to some embodiments. Process 800 may be performed by a recruiting platform and/or a candidate analysis platform, such as described with reference to FIG. 1.

Process 800 begins with step 810, in which a historic job request, a plurality of historic candidate profiles associated with the historic job request and candidate performance information associated with historic candidate profiles are obtained from a database. In some embodiments, the historic job request may be associated with a previously open position. In some embodiments, the candidate performance information may include information on how far candidates associated with the historic candidate profile progressed in a recruiting process associated with the open position.

Process 800 then proceeds to step 820. Step 820 involves using the plurality of historic candidate profiles and the candidate performance information, to generate a plurality of simulated candidate profiles by performing sub-steps 821-823.

In step 821, data is extracted from the plurality of historic candidate profiles to generate a plurality of candidate profile data segments. In some embodiments, the candidate profile data segments may correspond to sections of a resume of historic candidate profiles, a resume of historic candidate profiles, demographic information associated with historic candidate profiles, recruiter notes associated with historic candidate profiles, and interview notes associated with historic candidate profiles, among other data as described herein.

Process 800 then proceeds to step 822, in which the plurality of simulated candidate profiles is generated using the plurality of candidate profile data segments, by combining multiple candidate profile data segments of one or more historic candidate profiles. In some embodiments, the simulated candidate profiles are generated based in part on the candidate performance information associated with the profile data segments used in generating the simulated candidate profiles, such as described with reference to FIG. 6.

Process 800 then proceeds to step 823, in which a candidate quality score is determined for each of the simulated candidate profiles based on the candidate performance information associated with the candidate profile data segments used in generating the simulated candidate profiles. In some embodiments, the candidate quality score is indicative of the suitability of the candidate for the previously open position associated with the historic job request.

Process 800 then proceeds to step 830, in which a machine learning model configured to determine a candidate prediction score for one or more candidate profiles for a given job request is trained using the plurality of simulated candidate profiles. In some embodiments, the machine learning model is trained using the candidate quality scores of the simulated candidate profiles as ground truth data. In some embodiments, the machine learning model is trained as described with reference to FIGS. 6-7.

Process 800 then proceeds to step 840, in which a new job request including data related to an open position is obtained. In some embodiments, the job request may be obtained from a database or may be provided by a user, for example a recruiter user or a hiring party. The data related to the open job position may include data as described herein, for example an education requirement for the open position, a location for the open position, a salary for the open position, desired or required skills for the open position, desired or required certifications for the open position, daily responsibilities for the open position, and workplace preferences for the open position, among other data.

Process 800 then proceeds to step 850, in which a plurality of new candidate profiles is obtained. In some embodiments, the new candidate profiles are obtained from a database. In some embodiments the candidate profiles are determined by performing a keyword matching based on the job request or by comparing one or more attributes of the candidate profiles to the job request. In some embodiments, the new candidate profiles are obtained as described herein, for example as described with reference to FIGS. 1-2.

Process 800 then proceeds to step 860, in which a candidate prediction score is determined for each of the plurality of new candidate profiles based on the new job request using the trained machine learning model. In some embodiments, the candidate prediction scores may be determined as described herein, for example as described with reference to FIGS. 1-4B.

### Example Computer System

Various aspects and functions described herein may be implemented as specialized hardware or software components executing in one or more specialized computer systems. There are many examples of computer systems that are currently in use that could be specially programmed or specially configured. These examples include, among others, network appliances, personal computers, workstations, mainframes, networked clients, servers, media servers, application servers, database servers, and web servers. Other examples of computer systems may include mobile computing devices (e.g., smart phones, tablet computers, and personal digital assistants) and network equipment (e.g., load balancers, routers, and switches). Examples of particular models of mobile computing devices include iPhones, iPads, and iPod Touches running iOS operating systems available from Apple, Android devices like Samsung Galaxy Series, LG Nexus, and Motorola Droid X, Blackberry devices available from Blackberry Limited, and Windows Phone devices. Further, aspects may be located on a single computer system or may be distributed among a plurality of computer systems connected to one or more communications networks.

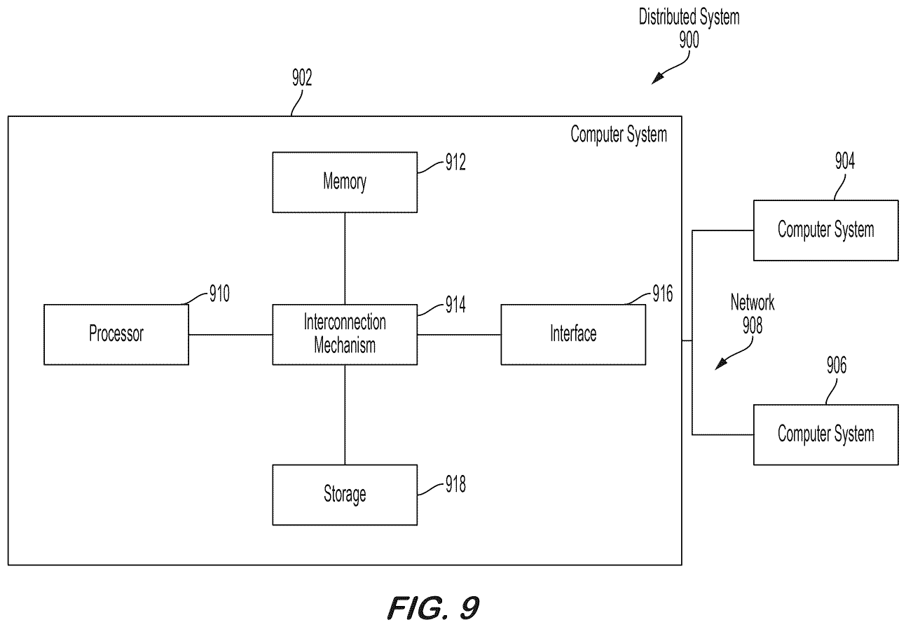

For example, various aspects, functions, and processes may be distributed among one or more computer systems configured to provide a service to one or more client computers, or to perform an overall task as part of a distributed system, such as the distributed computer system 900 shown in FIG. 9. Additionally, aspects may be performed on a client-server or multi-tier system that includes components distributed among one or more server systems that perform various functions. Consequently, embodiments are not limited to executing on any particular system or group of systems. Further, aspects, functions, and processes may be implemented in software, hardware or firmware, or any combination thereof. Thus, aspects, functions, and processes may be implemented within methods, acts, systems, system elements and components using a variety of hardware and software configurations, and examples are not limited to any particular distributed architecture, network, or communication protocol.

Referring to FIG. 9, there is illustrated a block diagram of a distributed computer system 900, in which various aspects and functions are practiced. As shown, the distributed computer system 900 includes one or more computer systems that exchange information. More specifically, the distributed computer system 900 includes computer systems 902, 904, and 906. As shown, the computer systems 902, 904, and 906 are interconnected by, and may exchange data through, a communication network 908. The network 908 may include any communication network through which computer systems may exchange data. To exchange data using the network 908, the computer systems 902, 904, and 906 and the network 908 may use various methods, protocols and standards, including, among others, Fiber Channel, Token Ring, Ethernet, Wireless Ethernet, Bluetooth, IP, IPV6, TCP/IP, UDP, DTN, HTTP, FTP, SNMP, SMS, MMS, SS22, JSON, SOAP, CORBA, REST, and Web Services. To ensure data transfer is secure, the computer systems 902, 904, and 906 may transmit data via the network 908 using a variety of security measures including, for example, SSL or VPN technologies. While the distributed computer system 900 illustrates three networked computer systems, the distributed computer system 900 is not so limited and may include any number of computer systems and computing devices, networked using any medium and communication protocol.

As illustrated in FIG. 9, the computer system 902 includes a processor 910, a memory 912, an interconnection element 914, an interface 916 and data storage element 918. To implement at least some of the aspects, functions, and processes disclosed herein, the processor 910 performs a series of instructions that result in manipulated data. The processor 910 may be any type of processor, multiprocessor or controller. Example processors may include a commercially available processor such as an Intel Xeon, Itanium, Core, Celeron, or Pentium processor; an AMD Opteron processor; an Apple A4 or A5 processor; a Sun UltraSPARC processor; an IBM Power5+ processor; an IBM mainframe chip; or a quantum computer. The processor 910 is connected to other system components, including one or more memory devices 912, by the interconnection element 914.

The memory 912 stores programs (e.g., sequences of instructions coded to be executable by the processor 910) and data during operation of the computer system 902. Thus, the memory 912 may be a relatively high performance, volatile, random access memory such as a dynamic random access memory (“DRAM”) or static memory (“SRAM”). However, the memory 912 may include any device for storing data, such as a disk drive or other nonvolatile storage device. Various examples may organize the memory 912 into particularized and, in some cases, unique structures to perform the functions disclosed herein. These data structures may be sized and organized to store values for particular data and types of data.

Components of the computer system 902 are coupled by an interconnection element such as the interconnection element 914. The interconnection element 914 may include any communication coupling between system components such as one or more physical busses in conformance with specialized or standard computing bus technologies such as IDE, SCSI, PCI and InfiniBand. The interconnection element 914 enables communications, including instructions and data, to be exchanged between system components of the computer system 902.

The computer system 902 also includes one or more interface devices 916 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 902 to exchange information and to communicate with external entities, such as users and other systems.

The data storage element 918 includes a computer readable and writeable nonvolatile, or non-transitory, data storage medium in which instructions are stored that define a program or other object that is executed by the processor 910. The data storage element 918 also may include information that is recorded, on or in, the medium, and that is processed by the processor 910 during execution of the program. More specifically, the information may be stored in one or more data structures specifically configured to conserve storage space or increase data exchange performance. The instructions may be persistently stored as encoded signals, and the instructions may cause the processor 910 to perform any of the functions described herein. The medium may, for example, be optical disk, magnetic disk or flash memory, among others. In operation, the processor 910 or some other controller causes data to be read from the nonvolatile recording medium into another memory, such as the memory 912, that allows for faster access to the information by the processor 910 than does the storage medium included in the data storage element 918. The memory may be located in the data storage element 918 or in the memory 912, however, the processor 910 manipulates the data within the memory, and then copies the data to the storage medium associated with the data storage element 918 after processing is completed. A variety of components may manage data movement between the storage medium and other memory elements and examples are not limited to particular data management components. Further, examples are not limited to a particular memory system or data storage system.

Although the computer system 902 is shown by way of example as one type of computer system upon which various aspects and functions may be practiced, aspects and functions are not limited to being implemented on the computer system 902 as shown in FIG. 9. Various aspects and functions may be practiced on one or more computers having a different architectures or components than that shown in FIG. 9. For instance, the computer system 902 may include specially programmed, special-purpose hardware, such as an application-specific integrated circuit (“ASIC”) tailored to perform a particular operation disclosed herein. While another example may perform the same function using a grid of several general-purpose computing devices running MAC OS System X with Motorola PowerPC processors and several specialized computing devices running proprietary hardware and operating systems.

The computer system 902 may be a computer system including an operating system that manages at least a portion of the hardware elements included in the computer system 902. In some embodiments, a processor or controller, such as the processor 910, executes an operating system. Examples of a particular operating system that may be executed include a Windows-based operating system, such as, the Windows-based operating systems, available from the Microsoft Corporation, a MAC OS System X operating system or an iOS operating system available from Apple Computer, one of many Linux-based operating system distributions, for example, the Enterprise Linux operating system available from Red Hat Inc., or a UNIX operating system available from various sources. Many other operating systems may be used, and examples are not limited to any particular operating system.

The processor 910 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as. Net, Java, C++, C #(C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some embodiments, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user space application) or in a commonly shared data structure (such as an application registry that is defined by an operating system). In addition, some examples provide for both system and user interfaces that allow external entities to modify the parameters and thereby configure the behavior of the components.

### Example Scoring System

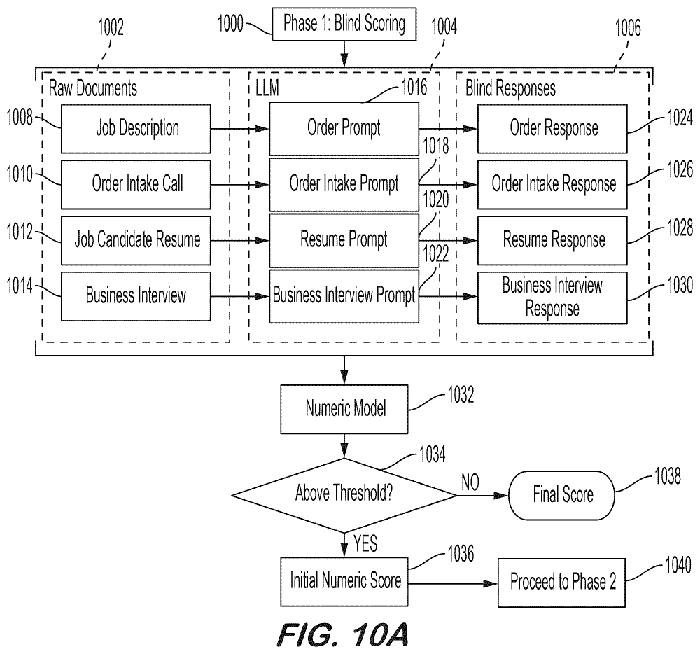

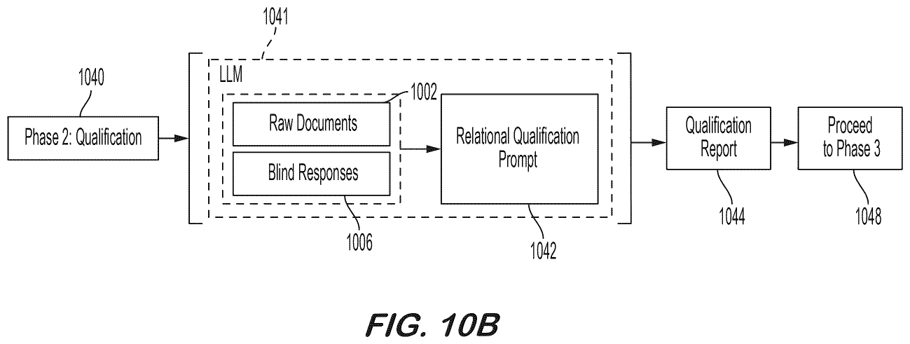

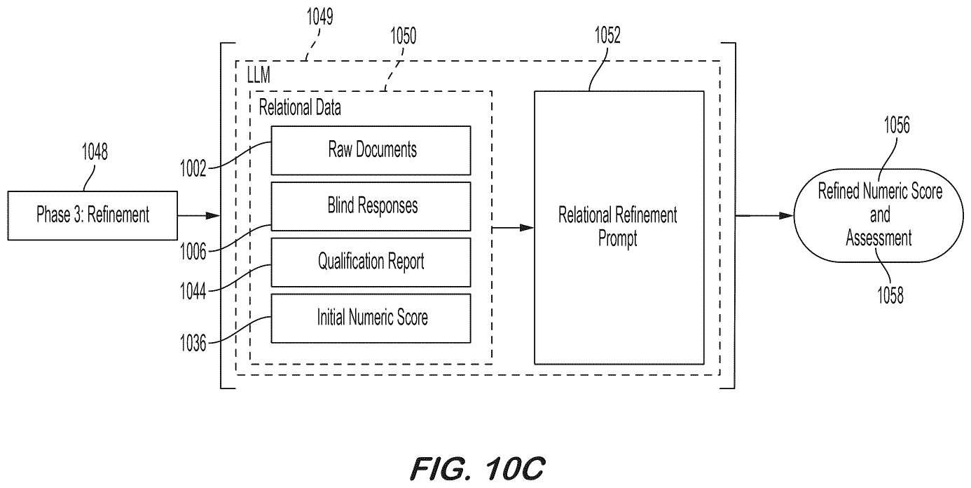

FIGS. 10A-C illustrate an example three-phase process for scoring candidates, according to some embodiments. The process for FIG. 10 may be performed by a candidate analysis system such as 120 of FIG. 1. FIG. 10A shows a first phase of the three-phase scoring process, a blind scoring phase 1000. FIG. 10B shows a second phase of the three-phase scoring process, a relational qualification phase 1040. FIG. 10C shows a third of the three-phase scoring process, a relational refinement phase 1048.

The blind scoring phase 1000 begins when the candidate analysis system 120 accesses information associated with a job candidate and a job opening and stores the information in a raw documents database 1002. In some embodiments, the data stored in the raw documents database 1002 includes a job description 1008 of the job opening, a transcript of an order intake call 1010, a job candidate resume 1012, and a transcript of a business interview 1014 with the business listing the job opening. In some embodiments, each document stored in the raw documents database 1002 is input into an LLM 1004 to convert these documents into structured, blind responses. In some embodiments, the output documents processed by the LLM 1004 are stored as json files. In some embodiments, each document stored in the raw documents database 1002 is processed by the LLM 1004 independently.

The LLM 1004 accesses the raw documents database 1002 as an input to generate a plurality of blind prompts. In some embodiments, the plurality of blind prompts includes an order prompt 1016, an order intake prompt 1018, a resume prompt 1020, and a business interview prompt 1022. In the embodiment in FIG. 10A, the LLM 1004 generates the order prompt 1016 using data from the job description 1008, generates the order intake prompt 1018 using data from the order intake call 1010, generates the resume prompt 1020 using data from the candidate resume 1012, and generates the 1022 using the data from the business interview 1014. In some embodiments, the generated blind prompts are uniform across job candidates applying to a given job opening. The LLM 1004 may include any externally hosted LLM, including, as an example, LLAMA 3.3.

In the embodiment in FIG. 10A, the responses from prompts generated by the LLM 1004 are saved as blind responses 1006. According to some embodiments, the blind responses are cached in memory such that the blind response data can be processed repeatedly without necessitating repeated LLM 1004 calls. In some embodiments, the LLM 1004 uses a jsonschema to define expected responses to the plurality of blind prompts. In some embodiments, the jsonschema includes hints as to how to fill out the blind prompt response fields in an expected json. In the embodiment in FIG. 10A, responses to the order prompt 1016 are stored as an order response 1024, responses to the order intake prompt 1018 are stored as an order intake response 1026, the responses to the resume prompt 1020 are stored as a resume response 1028, and the responses to the business interview prompt 1022 are stored as a business interview response 1030. The blind responses 1006 includes the order response 1024, the order intake response 1026, the 1028, and the business interview response 1030, as shown in FIG. 10A.

A numeric model 1032 uses the raw documents database 1002 and blind responses 1006 as inputs to output an initial numeric score 1036. In some embodiments, the initial numeric score 1036 ranges from 0 to 1. In some embodiments, the numeric model 1032 is a regression model trained on historic data of job candidate resumes 1012 to job openings. In some embodiments, the initial numeric score 1036 predicts the job candidate's success in the job opening with respect to the job application process. A threshold check 1034 compares the initial numeric score 1036 to a set numeric score. In some embodiments, the set numeric score is provided by the business posting the job opening. In embodiments, the set numeric score is determined by the candidate analysis system 120. If the assigned initial numeric score 1036 is less than the set numeric score, the job candidate is assigned a final score 1038 equal to their initial numeric score 1036. In some embodiments, an initial numeric score 1036 less than the set numeric score disqualifies the job candidate from further consideration for the job position. If the initial numeric score 1036 of the job candidate is at least equal to the set numeric score, the job candidate data undergoes further analysis by proceeding to the qualification phase 1040.

The qualification phase 1040 begins when the candidate analysis system 120 accesses the raw documents database 1002 and blind responses 1006 as inputs. An LLM 1041 analyzes the raw documents database 1002 and blind responses 1006 to output a relational qualification prompt 1042, as shown in FIG. 10B. In some embodiments, the relational qualification prompt 1042 includes a jsonschema which defines expected outputs from the LLM 1041. In some embodiments, the relational qualification prompt 1042 includes example input documents from which the LLM 1041 would process for assessment. The 1041 uses the raw documents database 1002, the blind responses 1006, and responses to the relational qualification prompt 1042 as inputs to output a qualification report 1044, which details contextual features of the job candidate relative to the job opening. In some embodiments, the qualification report 1044 is a json file matching the provided jsonschema. The LLM 1041 may include any externally hosted LLM, including, as an example, LLAMA 3.3.

Further job candidate analysis proceeds with the refinement phase 1048 begins when an LLM 1049 accesses a relational data database 1050 as an input. In the embodiment in FIG. 10C, the relational data database 1050 includes the raw documents database 1002, the blind responses 1006, the qualification report 1044, and the initial numeric score 1036. The LLM 1049 uses the relational data database 1050 to output a relational refinement prompt 1052. In some embodiments, the relational refinement prompt 1052 includes a jsonschema which defines expected outputs from the LLM 1049. In some embodiments, the relational refinement prompt 1052 includes example input documents from which the LLM 1041 analyzes. The LLM 1049 may include any externally hosted LLM, including, as an example, LLAMA 3.3. In some embodiments, the relational refinement prompt 1052 includes the raw documents database 1002 and any of all intermediate generated documents (e.g., the blind responses 1006, the qualification report 1044, the initial numeric score 1036, and/or the like) as inputs. In some embodiments, the raw documents database 1002 and the intermediate generated documents are stored as json files. The candidate analysis system 120 outputs both a refined numeric score 1056 and an assessment 1058 of the job candidate using the relational data database 1050 and responses to the relational refinement prompt 1052 as inputs. In some embodiments, the assessment 1058 explains the reason for the score that recruiters can use to evaluate the candidate match.

In some embodiments, the assessment 1058 includes a paragraph describing the strengths and/or weaknesses of a job candidate with respect to the job opening. As an example, the assessment 1058 of a job candidate with a high refined numeric score 1056 (e.g., 0.9 out of 1.0) could include a paragraph explaining their qualifications for the position. In some embodiments, this paragraph may include which skills a job candidate listed that are also listed in the job description 1008. As another example, the assessment 1058 of a candidate with a final score 1038 less than the set numeric score could include a paragraph explaining which skills listed in the job description 1008 are not included in the job candidate resume 1012.

Based on the foregoing disclosure, it should be apparent to one of ordinary skill in the art that the embodiments disclosed herein are not limited to a particular computer system platform, processor, operating system, network, or communication protocol. Also, it should be apparent that the embodiments disclosed herein are not limited to a specific architecture.

It is to be appreciated that embodiments of the methods and apparatuses described herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features described in connection with any one or more embodiments are not intended to be excluded from a similar role in any other embodiments.

The terms “approximately,” “substantially,” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for matching of job candidates to job openings, the method comprising:
obtaining a job request, the job request including data related to an open job position;
determining one or more recommended candidates for the job request, at least in part by:
identifying a first plurality of candidate profiles from a database based on the job request, each candidate profile being associated with a respective candidate;
providing, as inputs to a first trained machine learning model, the job request and a first set of questions related to the job request;
generating, using the first trained machine learning model, a first set of answers based on the job request and the first set of questions;
providing, as inputs to the first trained machine learning model, the first plurality of candidate profiles and a second set of questions related to the candidate profiles;
generating, using the first trained machine learning model, a plurality of second sets of answers based on the plurality of candidate profiles and the second set of questions; and
determining the one or more recommended candidates based on the first and second sets of answers; and
displaying a representation of the one or more recommended candidates on a user interface.

2. The method of claim 1, wherein determining the one or more recommended candidates based on the first and second sets of answers comprises:
generating, using a second trained machine learning model, a first data embedding based on the first set of answers and a plurality of second data embeddings based on the plurality of second sets of answers; and
determining, using a third trained machine learning model, a plurality of candidate prediction scores, each one of the plurality of candidate prediction scores being determined for each of plurality of second data embeddings, based on comparisons of the first data embedding and each of the plurality of second data embeddings,
wherein an act of determining the one or more recommended candidates is performed responsive to the act of determining the candidate prediction scores.

3. The method of claim 1, wherein the data of the job request includes one or more of: an education requirement for the open position, a location for the open position, a salary for the open position, skills for the open position, certifications for the open position, daily responsibilities for the open position, workplace preferences for the open position, and order intake summaries for the open position.

4. The method of claim 1, wherein a first candidate profile of the plurality of candidate profiles comprises data including a resume for a first candidate associated with the first candidate profile and one or more of: demographic information associated with the first candidate, recruiter notes associated with the first candidate, and interview notes associate with the first candidate.

5. The method of claim 1, wherein identifying the first plurality of candidate profiles comprises an act of comparing data of a second plurality of candidate profiles stored in the database to data of the job request and identifying the first plurality of candidate profiles from the second plurality of candidate profiles based on the act of comparing.

6. The method of claim 5, wherein the comparing comprises determining a level of matching between the data of the second plurality of candidate profiles and the data of the job request, and wherein candidate profiles of the first plurality of candidate profiles are identified when the level of matching exceeds a threshold level.

7. The method of claim 1, wherein the first set of questions include questions related to desired skills for the open position, required skills for the open position, workplace attributes for the open position, and responsibilities for the open position.

8. The method of claim 7, wherein the first set of questions is structured as a list of questions and further includes instructions for the first trained machine learning model to use in generating the first set of answers.

9. The method of claim 1, wherein the second set of questions include questions related to skills of a candidate, work history of the candidate, education of a candidate, past workplace attributes of the candidate, and past performance of the candidate.

10. The method of claim 9, wherein the second set of questions is structured as a list of questions and further includes instructions for the first trained machine learning model to use in generating the plurality of second sets of answers.

11. The method of claim 10, wherein the second set of questions further includes instructions for determining the plurality of second sets of answers based on content of the candidate profiles of the first plurality of candidate profiles.

12. The method of claim 1, wherein the first set of answers is structured as a list of answers to each of the first set of questions and the second set of answers is structured as a list of answers to each of the second set of questions.

13. The method of claim 1, wherein the first set of answers is structured as a paragraph summarizing answers to the first set of questions and the second set of answers are structured as a paragraph summarizing answers to the second set of questions.

14. The method of claim 1, wherein the first trained machine learning model is a large language model with a decoder-only transformer architecture.

15. The method of claim 14, wherein the first trained machine learning model is fine-tuned for analysis of candidate profiles and job requests.

16. The method of claim 2, wherein the second trained machine learning model is a large language model with an encoder-only transformer architecture and is fine-tuned to analyze information related to job postings and candidate profiles.

17. The method of claim 2, wherein the third trained machine learning model is an artificial neural network configured to determine the candidate prediction scores based on the first data embedding and the second data embeddings.

18. (canceled)

19. The method of claim 2, wherein the third trained machine learning model is trained using simulated candidate profiles, the simulated candidate profiles being generated using historic candidate profiles associated with one or more historic job requests stored in the database.

20. The method of claim 1, further comprising: obtaining updated candidate profiles of one or more candidates of the recommended candidates, the updated candidate profiles comprising new data related to the associated candidates with respect to the open job position.

21. The method of claim 20, wherein the new data comprises at least one of:
notes on the candidates provided by one or more recruiter users;
notes on one or more candidate interviews conducted in relation to the open position; or
transcripts of one or more candidate interviews conducted in relation to the open job position.

22.-23. (canceled)

24. The method of claim 20, further comprising:
providing, as inputs to the first trained machine learning model the updated candidate profiles and a third set of questions related to the new data, with respect to the open job position;
generating, using the first trained machine learning model, a plurality of third sets of answers based on the updated candidate profiles and the third set of questions; and
updating the recommended candidates based on the plurality of third sets of answers.

25. The method of claim 2, further comprising:
obtaining updated candidate profiles of one or more candidates of the recommended candidates, the updated candidate profiles comprising data related to the associated candidates with respect to the open job position;
providing, as inputs to the first trained machine learning model the updated candidate profiles and a third set of questions related to the data related to the candidate profiles with respect to the open job position;
generating, using the first trained machine learning model, a plurality of third sets of answers based on the updated candidate profiles and the third set of questions;
generating, using the second trained machine learning model, a plurality of third data embeddings based on the plurality of third sets of answers; and
determining, using the third trained machine learning model, updated candidate prediction scores for the candidates associated with each of plurality of third data embeddings.

26. A system for matching of job candidates to job openings, the system comprising:
a computer hardware processor;
a non-transitory computer readable storage medium, storing processor-executable instructions, that when executed by the computer hardware processor, cause the processor to perform a method for matching job candidates to a job opening, the method comprising:
obtaining a job request, the job request including data related to an open job position; and
determining one or more recommended candidates for the job request, at least in part by:
identifying a first plurality of candidate profiles from a database based on the job request, each candidate profile being associated with a respective candidate;
providing, as inputs to a first trained machine learning model, the job request and a first set of questions related to the job request;
generating, using the first trained machine learning model, a first set of answers based on the job request and the first set of questions;
providing, as inputs to the first trained machine learning model, the first plurality of candidate profiles and a second set of questions related to the candidate profiles;
generating, using the first trained machine learning model, a plurality of second sets of answers based on the plurality of candidate profiles and the second set of questions; and
determining the one or more recommended candidates based on the first and second sets of answers; and
displaying a representation of the one or more recommended candidates on a user interface.

27. At least one non-transitory computer readable storage medium, storing processor-executable instructions, that when executed by a computer hardware processor, cause the processor to perform a method for matching job candidates to a job opening, the method comprising:
obtaining a job request, the job request including data related to an open job position;
determining one or more recommended candidates for the job request, at least in part by:
identifying a first plurality of candidate profiles from a database based on the job request, each candidate profile being associated with a respective candidate;
providing, as inputs to a first trained machine learning model, the job request and a first set of questions related to the job request;
generating, using the first trained machine learning model, a first set of answers based on the job request and the first set of questions;
providing, as inputs to the first trained machine learning model, the first plurality of candidate profiles and a second set of questions related to the candidate profiles;
generating, using the first trained machine learning model, a plurality of second sets of answers based on the plurality of candidate profiles and the second set of questions; and
determining the one or more recommended candidates based on the first and second sets of answers; and
displaying a representation of the one or more recommended candidates on a user interface.

28.-62. (canceled)
